(19) United States
(12) Patent Application Publication
(10) Pub. No.: US 2026/0271154 A1
(43) Pub. Date: Sep. 10, 2026

(54) High-Efficiency LED Lighting Control System and Constant Current Control Circuit Therefor

(71) Applicant: Joulwatt Technology Co., Ltd., Hangzhou City (CN)

(72) Inventor: Guoqiang Liu, Hangzhou City (CN)

(21) Appl. No.: 19/554,138

(22) Filed: Mar. 2, 2026

(30) Foreign Application Priority Data
Mar. 5, 2025 (CN) 202510259037.4
Mar. 5, 2025 (CN) 202510260647.6

(51) Int. Cl. H05B 45/345

(52) U.S. Cl. CPC H05B 45/345

(57) ABSTRACT

This application discloses a high-efficiency LED lighting control system and a constant current control scheme therefor. The anode of an LED load is connected to an output terminal of a rectifier circuit. A first switch and two parallel capacitor paths are connected between a cathode of the LED load and ground. Each of the two parallel capacitor paths includes a first diode, an electrolytic capacitor, and a second switch connected in series. The two parallel capacitor paths are connected through a third switch such that when the third switch is turned on, the electrolytic capacitors in the two parallel capacitor paths form a series discharge path. A rectified half-wave voltage at a power frequency is used as an input voltage. Within different voltage ranges of the input voltage, different current paths are controlled to conduct, thereby increasing system input current width of the and improving system efficiency.

### CROSS-REFERENCE TO RELATED APPLICATIONS

This patent application claims priority to China Patent Application No. 202510259037.4 filed on March 5, 2025, and China Patent Application No. 202510260647.6 filed on March 5, 2025. The aforementioned applications are hereby incorporated by reference herein as if reproduced in their entireties.

### TECHNICAL FIELD

The present disclosure relates generally to the field of lighting technologies, and in particular embodiments, to techniques and mechanisms for a high-efficiency LED lighting control system and a constant current control circuit therefor.

### BACKGROUND

Light-emitting diodes (LEDs) have advantages over traditional light sources, such as high efficiency, energy saving, environmental friendliness, and good color rendering. As a result, LEDs are increasingly replacing traditional light sources and are widely used in the lighting field.

Linear LED drivers have seen significant development in recent years as a mainstream LED driver solution. However, since the efficiency of linear solutions depends on the voltage difference between input and output voltages, when the voltage difference is large, it is difficult to meet the standard requirements for efficiency and power factor (PF). To achieve a PF of 0.9, the input current needs to be as wide as possible and close to the phase of the input voltage. This requires a lower output voltage for linear solutions. If the PF is increased to be above 0.9 by reducing the output voltage, the input-output conversion efficiency is usually below 75%. Therefore, the linear LED driver solutions cannot be applied to application scenarios where a PF greater than 0.9 is required while high efficiency also is maintained.

Therefore, it is desirable to provide improved technical solutions to overcome the above-mentioned technical problems existing in the art.

### SUMMARY

In view of above, an objective of the present disclosure is to provide a high-efficiency LED lighting control system and a control method to solve the technical problem of low efficiency of linear LED driving in the art.

Technical advantages are generally achieved, by embodiments of this disclosure which describe a high-efficiency LED lighting control system and a constant current control circuit therefor.

In accordance with one aspect of the present disclosure, an LED lighting control system for controlling an LED load is provided, comprising: a rectifier circuit, configured to rectify an alternating current to obtain a half-wave power frequency input voltage, an anode of the LED load being connected to an output terminal of the rectifier circuit; a first switch, connected between a cathode of the LED load and ground; two parallel capacitor paths, connected between the cathode of the LED load and the ground, each capacitor path of the two parallel capacitor paths including a first unidirectional conducting element, a first electrolytic capacitor, and a second switch, and the first unidirectional conducting element being connected to the cathode of the LED load; and a third switch, connecting the two parallel capacitor paths such that when the third switch is turned on, two first electrolytic capacitors in the two parallel capacitor paths form a series discharge path.

Optionally, when the input voltage is lower than a first threshold voltage, the first switch is turned on, the third switch is turned on, and the two first electrolytic capacitors in the parallel capacitor paths supply power to the LED load; when the input voltage is higher than the first threshold voltage and lower than a second threshold voltage, the first switch is turned on, the two parallel capacitor paths are disconnected, and the input voltage supplies power to the LED load; when the input voltage is higher than the second threshold voltage, the first switch is turned off, the two parallel capacitor paths conduct, and the input voltage supplies power to the LED load and charges the two first electrolytic capacitors in the two parallel capacitor paths; and the first threshold voltage is a load operating voltage, and the second threshold voltage is a sum of the load operating voltage and a electrolytic capacitor voltage.

Optionally, the LED lighting control system further comprises a second unidirectional conduction element, wherein the two parallel capacitor paths include a first capacitor path and a second capacitor path, a first terminal of the first electrolytic capacitor in the first capacitor path is connected to the second switch in the first capacitor path, and a second terminal of the first electrolytic capacitor in the first capacitor path is connected to a first power terminal of the third switch, a first terminal of the first electrolytic capacitor in the second capacitor path is connected to a second power terminal of the third switch, and to the second switch in the second capacitor path, and the second unidirectional conducting element is connected between the second terminal of the first electrolytic capacitor in the second capacitor path and the anode of the LED load.

Optionally, when the input voltage is lower than the first threshold voltage, the first switch is turned on, and the third switch is turned on, a current flows sequentially from the first electrolytic capacitor in the first capacitor path, through the third switch, the first electrolytic capacitor in the second capacitor path to the LED load, forming a power circuit through the first switch.

Optionally, the first unidirectional conducting element includes a diode, which has an anode connected to the LED load and a cathode connected to the first electrolytic capacitor or the second switch.

Optionally, the LED lighting control system further comprises a first switch control circuit for controlling the first switch, wherein the first switch control circuit is configured to: receive a first reference voltage and a first current feedback signal, and amplify an error between the first reference voltage and the first current feedback signal to obtain a first error output signal to control conduction state of the first switch.

Optionally, the LED lighting control system further comprises two second switch control circuits, configured to control respectively second switches in the two parallel capacitor paths, wherein each of the two second switch control circuits is configured to receive a reference voltage and a current feedback signal, and obtain an error output signal by amplifying an error between the reference voltage and the current feedback signal, to control a conduction state of the second switch.

Optionally, the LED lighting control system further comprises a third capacitor path connected between the cathode of the LED load and the ground, the third capacitor path including a third electrolytic capacitor connected to the two parallel capacitor paths through a fourth switch; wherein when the input voltage is lower than the first threshold voltage, the third switch and the fourth switch are turned on, and the two first electrolytic capacitors in the two parallel capacitor paths and the third electrolytic capacitor in the third capacitor path discharge in series to supply power to the LED load.

In accordance with another aspect of the present disclosure, a constant current control circuit for an LED lighting control system is provided, the LED lighting control system comprising a rectifier circuit and a plurality of LED current paths, wherein an anode of an LED load is configured to receive a half-wave power frequency input voltage that is output from the rectifier circuit, and the plurality of LED current paths are connected between a cathode of the LED load and ground; wherein the plurality of LED current paths include a first switching current path and at least two parallel capacitor current paths; and wherein the constant current control circuit is connected to a current sampling terminal of the plurality of LED current paths and a current control terminal of the plurality of LED current paths; and the constant current control circuit comprises: a signal control circuit configured to: receive feedback current sampling information from the plurality of LED current paths and amplify an error between the feedback current sampling information and a reference value to generate a plurality of reference signals; and a plurality of operational amplifiers, configured to amplify errors between the feedback current sampling information of the plurality of LED current paths and the plurality reference signals, to control one or more operating currents of the plurality of LED current paths based on error amplification results, thereby realizing constant current control of the LED load.

Optionally, the first switching current path includes a first switch; the at least two parallel capacitor current paths include a first capacitor current path and a second capacitor current path, and each of the first capacitor current path and the second capacitor current path includes a second switch; the plurality of reference signals include a first reference signal, a second reference signal, and a third reference signal; and the constant current control circuit is configured to: amplify an error between the feedback current sampling information of the first switching current path and the first reference signal, and control an operating state of the first switch according to an error amplification result to control a current of the first switching current path; and amplify errors between the feedback current sampling information of the first capacitor current path and the second capacitor current path and the second reference signal and the third reference signal respectively, and control an operating state of the second switch of a corresponding capacitor current path according to a corresponding error amplification result to control a current of the corresponding capacitor current path.

Optionally, the LED lighting system further includes a third switch connected between two parallel capacitor current paths of the at least two parallel capacitor current paths; and when the third switch is turned on, electrolytic capacitors in the two parallel capacitor current paths supply power to the LED load.

Optionally, the constant current control circuit further comprises a voltage comparison circuit configured to: receive the input voltage and a first threshold voltage; and when the input voltage is less than the first threshold voltage, output a comparison signal to control to turn on the third switch; wherein the first threshold voltage is less than or equal to a load operating voltage.

Optionally, when the input voltage is higher than the first threshold voltage and lower than a second threshold voltage, the first switch is turned on, the at least two parallel capacitor current paths are disconnected, and the input voltage supplies power to the LED load; and when the input voltage is higher than the second threshold voltage, the first switch is turned off, the at least two parallel capacitor current paths conduct, and the input voltage supplies power to the LED load and charges electrolytic capacitors in the at least two parallel capacitor current paths; the second threshold voltage is a sum of the load operating voltage and an electrolytic capacitor voltage.

Optionally, the constant current control circuit is further configured to: obtain first feedback current sampling information by sampling a current of the first switching current path through a first sampling resistor; and obtain second feedback current sampling information and third feedback current sampling information by sampling current information of the two parallel capacitor current paths through a second sampling resistor and a third sampling resistor.

Optionally, resistance values of the first sampling resistor, the second sampling resistor, and the third sampling resistor are same, and a value of the first reference signal is different from a value of the second reference signal, and the values of the second reference signal and the third reference signal are same.

Optionally, resistance values of the first sampling resistor and the second sampling resistor are different, the second sampling resistor and the third sampling resistor have a same resistance value, and values of the first reference signal, the second reference signal, and the third reference signal are same.

Optionally, the constant current control circuit further comprises a first operational amplifier, configured to receive the feedback current sampling information from the first switching current path and the first reference signal, and output the error amplification result to a control terminal of the first switch; a second operational amplifier and a third operational amplifier, configured to receive respectively the feedback current sampling information from the first capacitor current path and the second capacitor current path, the second reference signal and the third reference signal, and respectively transmit error amplification results to control terminals of the second switches of first capacitor current path and the second capacitor current path.

Optionally, the constant current control circuit further comprises a reference voltage generation circuit configured to: receive feedback current sampling information from the plurality of LED current paths and a reference value; obtain a first current based on the reference value, and obtain a second current based on the feedback current sampling information of the plurality of LED current paths; wherein a capacitor voltage is obtained by using the first current and the second current charging and discharging an electrolytic capacitor, and the plurality of reference signals are obtained by multiplying the capacitor voltage by different coefficients.

Optionally, the constant current control circuit further comprises a zeroth switching current path connected between an output terminal of the rectifier circuit and the ground, the zeroth switching current path includes a zeroth switch; wherein when the input voltage is less than a first threshold voltage, the zeroth switch is turned on, and the zeroth switch current path forms a conduction loop with the rectifier circuit, the first threshold voltage being less than or equal to a load operating voltage.

Optionally, the constant current control circuit further comprises a first diode, wherein an anode of the first diode is connected to an output terminal of the rectified current, and a cathode of the first diode is connected to the anode of the LED load; and a connection node of the zeroth switching current path is connected between the output terminal of the rectifier circuit and the anode of the first diode.

Optionally, the at least two parallel capacitor current paths further include a third capacitor current path, the third capacitor current path including a fourth switch, and the plurality of reference signals further include a fourth reference signal. The constant current control circuit is configured to amplify an error between feedback current sampling information of the third capacitor current path and the fourth reference signal, and control the operating state of the fourth switch according to an error amplification result to control a current of the third capacitor current path.

The LED lighting control system of the present disclosure obtains a half-wave power input voltage after rectifying an alternating current by a rectifier circuit. The anode of an LED load is connected to the output terminal of the rectifier circuit. A first switching current path and at least two parallel capacitor current paths are connected between the cathode of the LED load and ground. The first switching current path includes a first switch. Each capacitor current path includes a first diode, a first electrolytic capacitor, and a second switch connected in series. The parallel capacitor current paths are connected through a third switch such that when the third switch is turned on, the electrolytic capacitors in the parallel capacitor current paths form a series discharge path. The half-wave power frequency rectified voltage serves as an input voltage. Different current paths are controlled to conduct within different voltage ranges of the input voltage, such that the LED load can be powered within different input voltage ranges, and the input current range is wide. The technical solution of this application utilizes the lossless characteristics of electrolytic capacitors, combines and controls the electrolytic capacitors for different input voltage ranges, to achieve an effect of satisfying a wide input current range in a power frequency half-wave, which improves the power factor while ensuring relatively high conversion efficiency.

The constant current control circuit of the LED lighting control system of the present disclosure includes a rectifier circuit and multiple LED current paths. The anode of an LED load is connected to the output of the rectifier circuit to receive a half-wave power frequency input voltage of the. The multiple LED current paths are connected between the cathode of the LED load and ground. These multiple LED current paths include a first switching current path and at least two parallel capacitor current paths. The constant current control circuit receives feedback current sampling information from the multiple LED current paths and amplifies errors with respect to a reference value to generate multiple reference voltage signals for use by the multiple LED current paths, thereby realizing closed-loop control of the LED load current. The constant current control circuit of the present application achieves low harmonic, high-efficiency linear LED drive constant current control for a single-range LED load with good constant current control accuracy.

The foregoing has outlined rather broadly the features and technical advantages of the present disclosure in order that the detailed description of the disclosure that follows may be better understood. Additional features and advantages of the disclosure will be described hereinafter which form the subject of the claims of the disclosure. It should be appreciated by those skilled in the art that the conception and specific embodiment disclosed may be readily utilized as a basis for modifying or designing other structures or processes for carrying out the same purposes of the present disclosure. It should also be realized by those skilled in the art that such equivalent constructions do not depart from the spirit and scope of the disclosure as set forth in the appended claims.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a circuit block diagram of a first LED lighting control system according to embodiments of the present disclosure;

FIG. 2 is a circuit diagram of an example implementation of the first LED lighting control system according to embodiments of the present disclosure;

FIG. 3 is a schematic diagram of the first LED lighting control system, highlighting some current loops, according to embodiments of the present disclosure;

FIG. 4 is a schematic diagram of the first LED lighting control system, highlighting another current loop, according to embodiments of the present disclosure;

FIG. 5 is an operation waveform diagram of FIG. 1 according to embodiments of the present disclosure;

FIG. 6A is a circuit diagram of a second LED lighting control system according to embodiments of the present disclosure, highlighting some current loops, according to embodiments of the present disclosure;

FIG. 6B is a diagram of a signal control circuit in a constant current control circuit according to embodiments of the present disclosure, where the constant current control circuit is applicable to the first LED lighting control system and the second lighting control system;

FIG. 7 is a schematic diagram of the second LED lighting control system, highlighting another current loop, according to embodiments of the present disclosure;

FIG. 8 is a circuit diagram of an example implementation of a reference voltage generation circuit in FIG. 6 according to embodiments of the present disclosure; and

FIG. 9 is an operation waveform diagram FIG. 6A according to embodiments of the present disclosure.

Corresponding numerals and symbols in the different figures generally refer to corresponding parts unless otherwise indicated. The figures are drawn to clearly illustrate the relevant aspects of the embodiments and are not necessarily drawn to scale.

### DETALED DESCRIPTION OF ILLUSTRATIVE EMBODIMENTS

The making and using of embodiments of this disclosure are discussed in detail below. It should be appreciated, however, that the concepts disclosed herein can be embodied in a wide variety of specific contexts, and that the specific embodiments discussed herein are merely illustrative and do not serve to limit the scope of the claims. Further, it should be understood that various changes, substitutions and alterations can be made herein without departing from the spirit and scope of this disclosure as defined by the appended claims.

Furthermore, one or more features from one or more of the following described embodiments may be combined to create alternative embodiments not explicitly described, and features suitable for such combinations are understood to be within the scope of this disclosure. It is therefore intended that the appended claims encompass any such modifications or embodiments.

Embodiments of the present disclosure are described in detail below with reference to the accompanying drawings, but the present disclosure is not limited to these embodiments. The present disclosure covers any substitutions, modifications, equivalent methods, and solutions made within the spirit and scope of the present disclosure.

To facilitate a thorough understanding of the present disclosure, specific details are described in detail in the following embodiments of the present disclosure, but those skilled in the art can fully understand the present disclosure without these details.

The present disclosure is described in more detail below by way of examples with reference to the accompanying drawings. It should be noted that the drawings are in a simplified form and use non-precise proportions, and are only used to facilitate and clarify the illustration of the embodiments of the present disclosure.

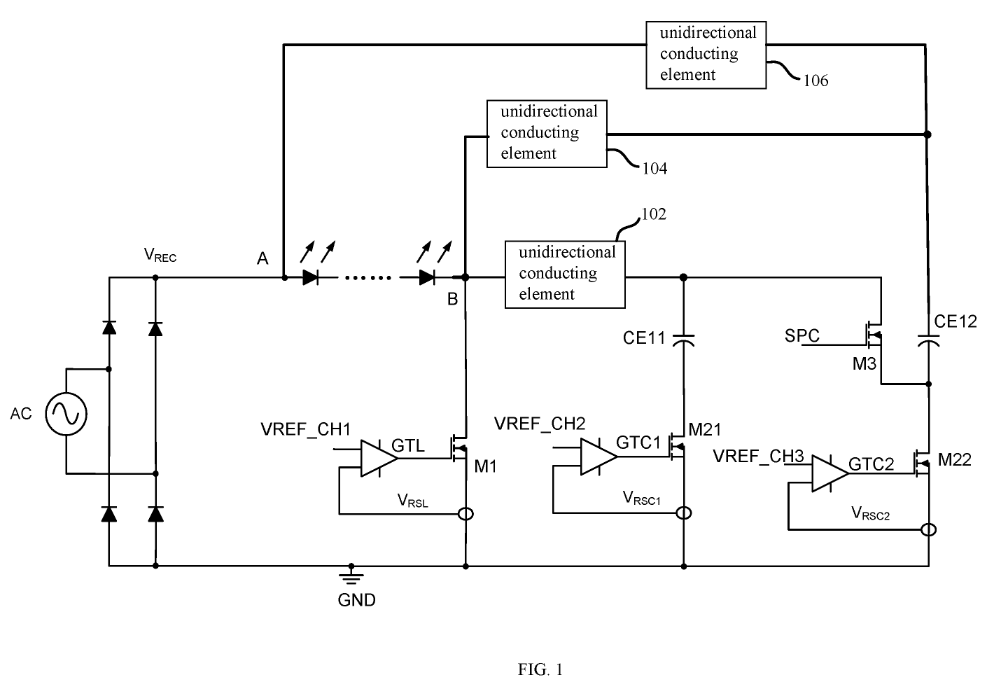

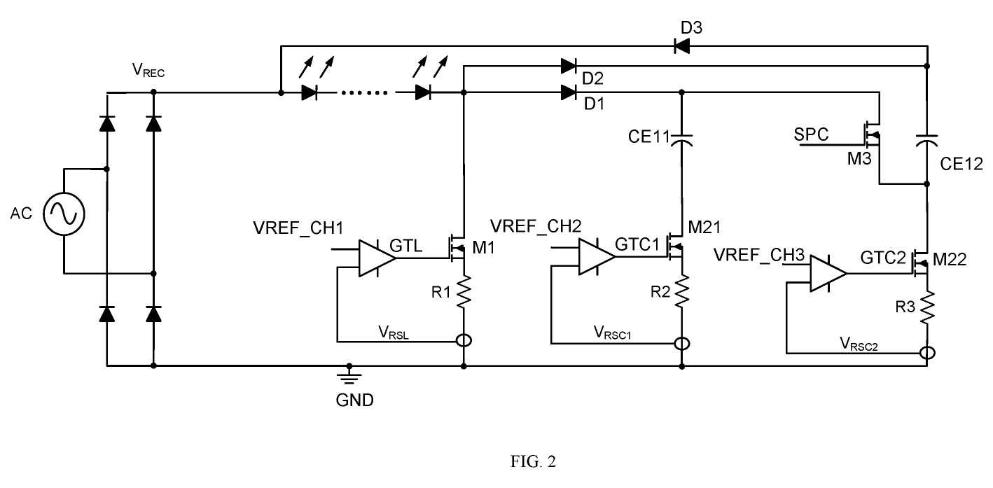

FIG. 1 is a circuit block diagram of an LED lighting control system according to embodiments of the present disclosure. FIG. 2 is a circuit diagram of an example implementation of the LED lighting control system according to embodiments of the present disclosure. The LED lighting control system may be configured for controlling and driving an LED load. As shown in FIG. 1 and FIG. 2, the LED lighting control system may include a rectifier circuit. After an alternating current is rectified by the rectifier circuit, a half-wave input voltage V_{REC} at a power frequency (may also be referred to as a half-wave input power frequency voltage thereafter) is obtained_{.} The anode of the LED load is connected to an output terminal of the rectifier circuit, and a connection node between the LED load and the output terminal of the rectifier circuit is denoted as a node A. A first switch M1 is connected between the cathode of the LED load and ground. Two parallel capacitor paths are connected between the cathode of the LED load and the ground in parallel. Each of the two parallel capacitor paths (each of which may also be referred to as a capacitor path) includes a first unidirectional conducting element (102 or 104), a first electrolytic capacitor (CE11 or CE12), and a second switch (M21 or M22). For example, a first capacitor path includes the first unidirectional conducting element 102, the first electrolytic capacitor CE11 and the second switch M21, and a second capacitor path includes the first unidirectional conducting element 104, the first electrolytic capacitor CE12 and the second switch M22. The first unidirectional conducting element is connected to the cathode of the LED load. A third switch M3 is used to connect the two parallel capacitor paths such that when the third switch M3 is turned on, the first electrolytic capacitors CE11 and CE12 in the two parallel capacitor paths form a series discharge path. Here, the node where the cathode of the LED load is connected to the first switch M1 is denoted as a node B. In this embodiment, the first unidirectional conducting element may include a diode such as diode D1 or D2, whose anode is connected to the cathode of the LED load, and whose cathode is connected to the first electrolytic capacitor or the second switch in a corresponding capacitor path. The connection positions of the first electrolytic capacitor and the second switch in the capacitor path may be interchanged.

Furthermore, the LED lighting control system also includes a second unidirectional conducting element 106, which may include a diode D3. The two parallel capacitor paths include the first capacitor path and the second capacitor path as described above. In the first capacitor path, a first terminal of the electrolytic capacitor CE11 is connected to the second switch M21 in that path, and a second terminal of the electrolytic capacitor CE11 is connected to a first power terminal of the third switch M3. In the second capacitor path, a first terminal of the electrolytic capacitor CE12 is connected to a second power terminal of the third switch M3, and the first terminal of the electrolytic capacitor CE12 in the second capacitor path is also connected to the second switch M22 in that path. The second unidirectional conducting element 106 is connected between a second terminal of the first electrolytic capacitor CE12 and the anode of the LED load, i.e., connected to the node A. Here, the first and second unidirectional conducting elements are exemplified by diodes, but they may also be other switches or combinations of switches, as long as they can achieve the unidirectional conducting function.

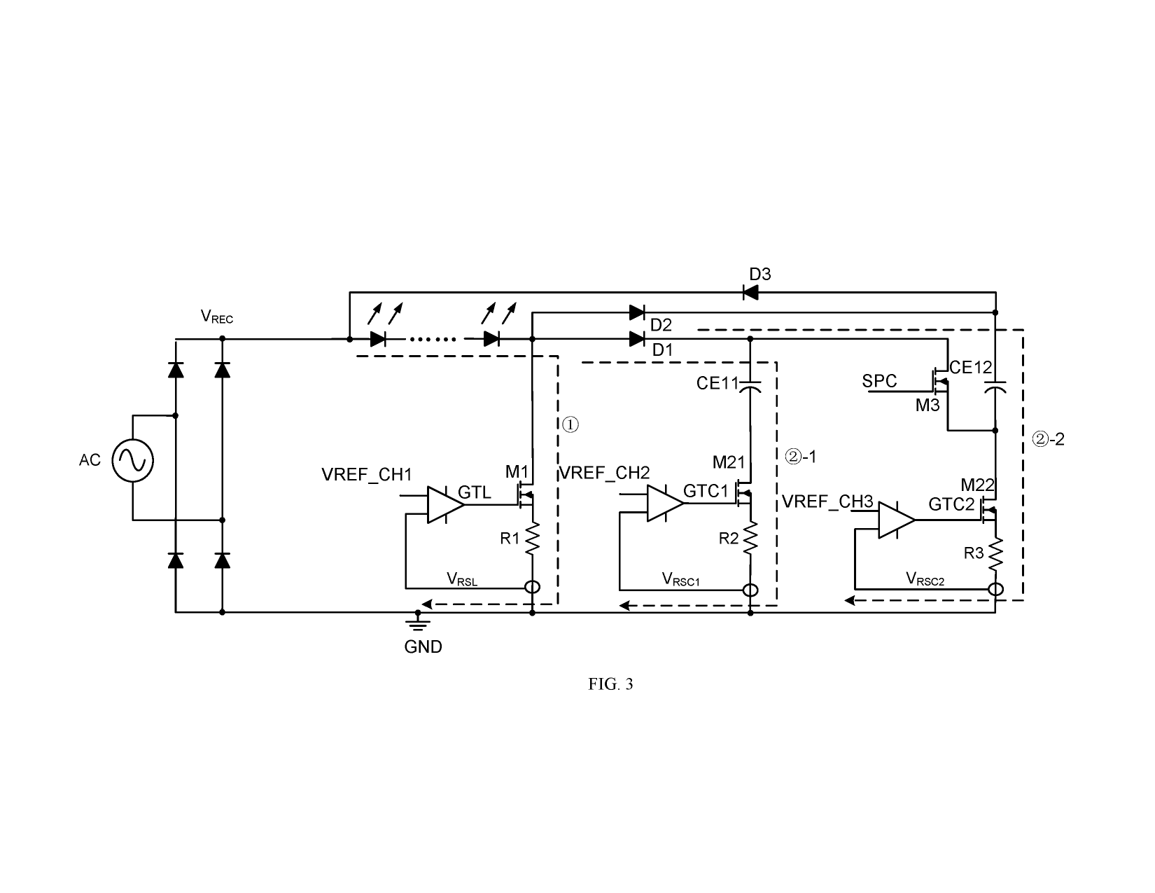

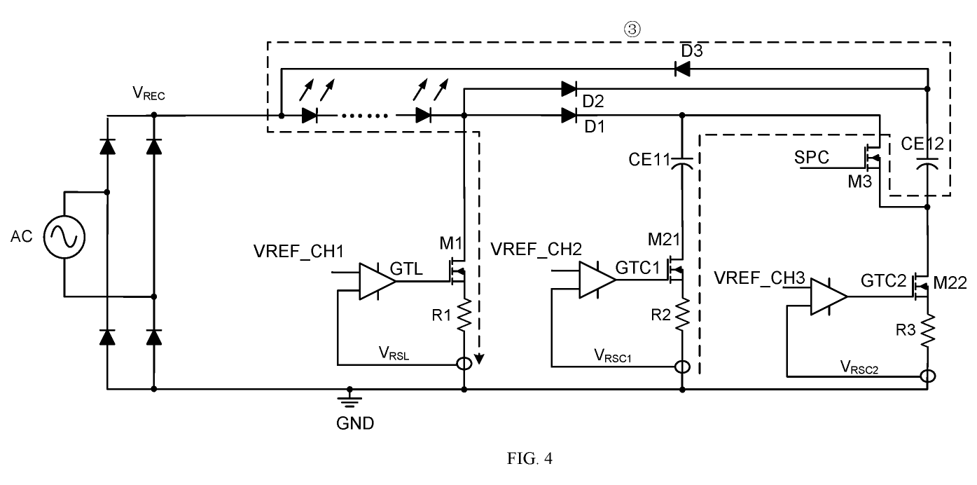

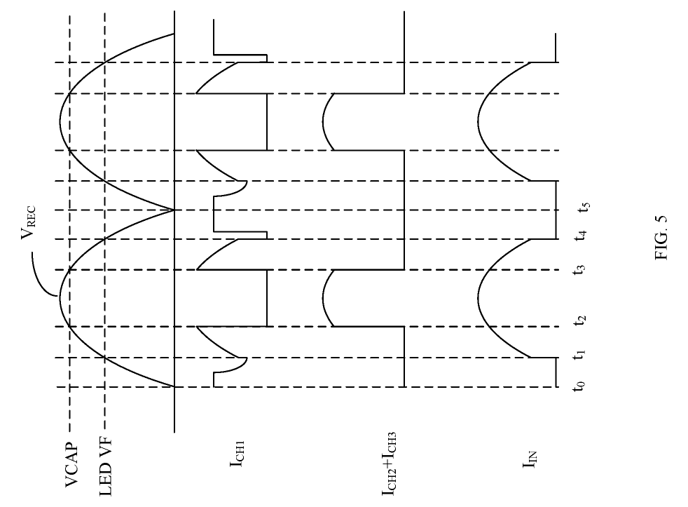

FIG. 3 is a schematic diagram of some different current loops of the LED lighting control system according to embodiments of the present disclosure. FIG. 4 is a schematic diagram of another current loop of the LED lighting control system according to embodiments of the present disclosure. FIG. 5 is a waveform diagram. Based on the above system frame, the first LED control scheme of the present disclosure is described as follows.

When the input voltage V_{REC} (at the output terminal of the rectifier circuit) is lower than a first threshold voltage V_{F}, the first switch M1 is turned on, the third switch M3 is turned on, and the two electrolytic capacitors in the parallel capacitor path supply power to the LED load. Specifically, the current flows sequentially from the electrolytic capacitor CE11 in the first capacitor path, the third switch M3, the electrolytic capacitor CE12 in the second capacitor path, and the second unidirectional conducting element D3 to the LED load, and forms a power loop through the first switch M1, as shown by a current loop ③ in FIG. 4.

When the input voltage V_{REC} is higher than the first threshold voltage V_{F} andlower than a second threshold voltage V_{CAP}, the first switch M1 is turned on, and the parallel capacitor paths are disconnected; that is, the second switches are turned off, and the input voltage forms a path through a current path where the first switch M1 is located to supply power to the LED load, such as a current loop ① as shown in FIG. 3. Specifically, in current loop ① of FIG. 3, current flows sequentially from the output terminal of the rectifier circuit to the LED load, the first switch M1 and ground, thereby forming a current loop.

When the input voltage V_{REC} is higher than the second threshold voltage V_{CAP}, the first switch M1 is turned off, the parallel capacitor paths conduct, that is, the second switches are turned on, and the input voltage V_{REC} suppliespower to the LED load and charges the electrolytic capacitors CE11 and CE12 in the capacitor paths, such as a current loop ②-1 and a current loop②-2 as shown in FIG. 3. The first threshold voltage V_{F} may be a load operating voltage, and the second threshold voltage may the sum of the load operating voltage and an electrolytic capacitor voltage. Specifically, in current loop ②-1 of FIG. 3, current flows sequentially from the output terminal of the rectifier circuit to the LED load, the diode D1, the electrolytic capacitor CE11, the second switch M21 and ground, thereby forming a current loop. In current loop ②-2 of FIG. 3, current flows sequentially from the output terminal of the rectifier circuit to the LED load, the diode D2, the electrolytic capacitor CE12, the second switch M22 and ground, thereby forming a current loop.

FIG. 5 is a waveform diagram based on FIG. 1. Within the period of the half-wave power frequency input voltage V_{REC}, and in the time interval t0-t1, the input voltage V_{REC} islower than the first threshold voltage V_{F}, the parallel electrolytic capacitors CE11 and CE12 supply power to the LED load together. A current I_{CH1} flows through a circuit branch where the first switch M1 is located, andno current flows through the parallel capacitor paths. I_{CH2} and I_{CH3}are zero. As used herein, I_{CH1}represents a current flowing through M1 (or current loop ① or current loop ⑤), and I_{CH2} and I_{CH3}represent currents flowing through M21 (or current loop ②-1) and M22 (or current loop ②-2).

In the time interval t1-t2, the input voltage V_{REC} is higher than the first threshold voltage V_{F} but lower than the second threshold voltage V_{CAP}, the current I_{CH1} flows through the circuit branch where the first switch M1 is located, and no current flows through the parallel capacitor paths. I_{CH2} and I_{CH3}are zero.

In the time interval t2-t3, the input voltage V_{REC} is higher than the second threshold voltage V_{CAP}, no current flows through the circuit branch where the first switch M1 is located, current flows through the parallel capacitor paths, and I_{CH2} and I_{CH3} aregreater than 0.

In the time interval t3-t4, the input voltage V_{REC} decreases to be lower than the second threshold voltage V_{CAP} but higher than the first threshold voltage V_{F}, similar to the situation during t1-t2, the current I_{CH1} flows through the circuit branch where the first switch M1 is located. No current flows through the parallel capacitor paths, and I_{CH2} and I_{CH3} are zero. Then, during the time interval t4-t5, the input voltage V_{REC} decreases to be or less than the first threshold voltage V_{F}. Similar to the situation during t0-t1, the current I_{CH1}flows through the circuit branch where the first switch M1 is located. Based on this process, the system's input current waveform is shown by I_{IN}, which closely approximates the input voltage waveform, resulting in a better power factor and lower harmonics.

Referring to FIGS. 1-4, the LED lighting control system of embodiments of the present disclosure further includes a first switch control circuit for controlling the first switch M1. The first switch control circuit is configured to receive and amplify a first reference voltage VREF_CH1 and a first current feedback signal, to obtain a first error output signal (GTL). The first error output signal is used to control the conduction state of the first switch M1. The first switch control circuit 108 includes an error amplifier. The LED lighting control system may also include two second switch control circuits, which are used to control the second switches (M21, M22) in the parallel capacitor paths respectively. Each second switch control circuit is configured to receive and amplify a reference voltage (VREF_CH2 or VREF_CH3) and a corresponding second current feedback signal, to obtain a second error output signal (GTC1 or GTC2). The second error output signal is used to control the conduction state of the corresponding second switch.

Embodiments of the present disclosure control the conduction of different current paths when the input voltage is within different input voltage ranges, such that the LED load is powered over various input voltage ranges, with a wide input current range. The technical solution utilizes the lossless characteristics of electrolytic capacitors, combines and controls the electrolytic capacitors for different input voltage ranges, to achieve an effect of satisfying a wide input current range in a power frequency half-wave, which improves the power factor while ensuring relatively high conversion efficiency. Compared to traditional single-range linear solutions, this improves efficiency by more than 10%, significantly enhancing the overall light energy efficiency and providing a feasible alternative to switching power supply solutions.

FIG. 4 illustrates that the LED lighting control system is configured with two parallel capacitor paths, with the number of capacitor paths not limited thereto. In another embodiment, the LED lighting control system may further include a third capacitor path. The third capacitor path is connected between the cathode of the LED load and the ground, and between the node B and the ground. Therefore, the third capacitor path is connected in parallel with the first and second capacitor paths. The first, second and third capacitor paths are collectively referred to as three parallel capacitor paths. The third capacitor path includes a third electrolytic capacitor and a switch connected to the third electrolytic capacitor. The third capacitor path may also be connected to the two parallel capacitor paths via a fourth switch. When the input voltage V_{REC} is lower than the first threshold voltage V_{F}, both the third and fourth switches are turned on, and the electrolytic capacitors in the three parallel capacitor paths discharge in series to power the LED load. This embodiment has one more capacitor path than the previous embodiment, which allows for further reduction in the capacity of the electrolytic capacitors, lowering costs. Furthermore, it allows for selection of two of the three electrolytic capacitors to power the LED load, providing greater flexibility in power supply.

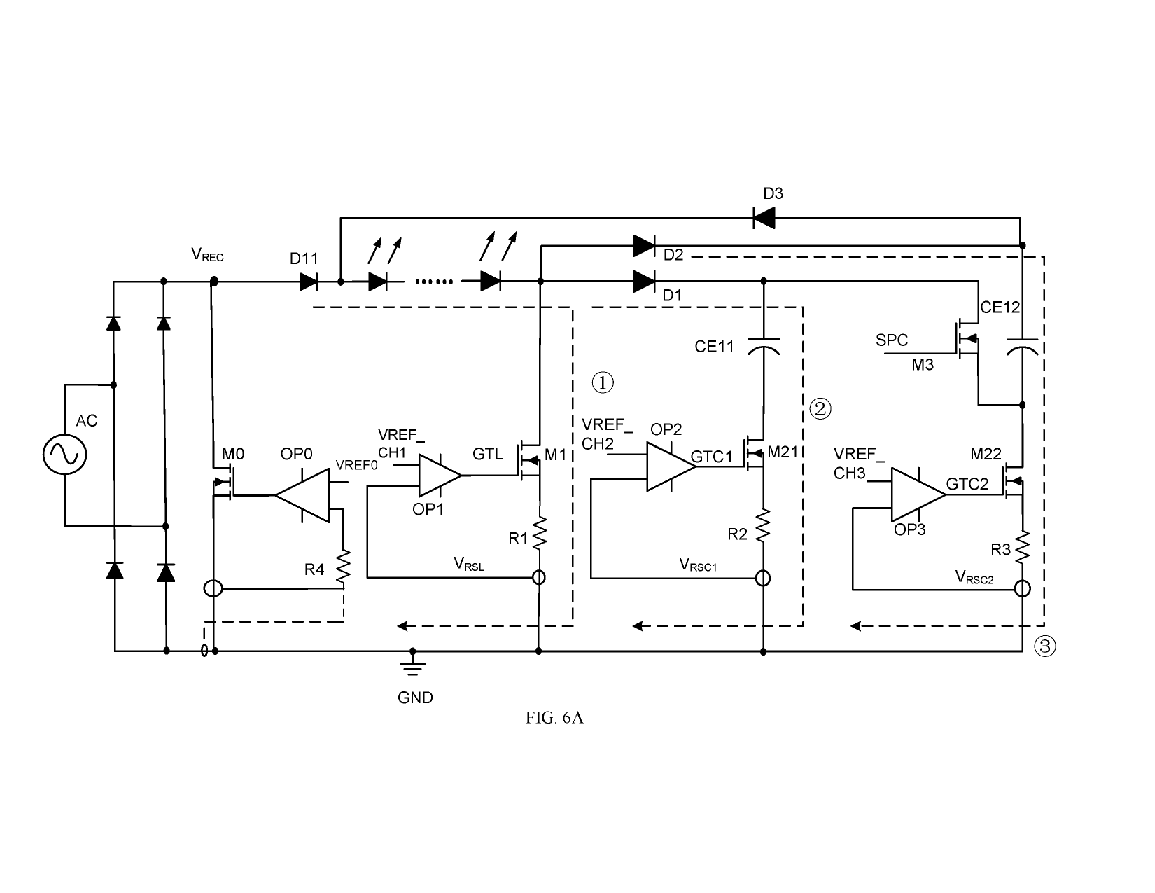

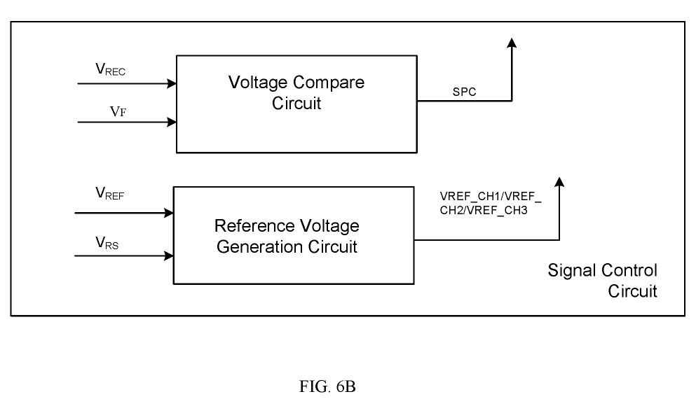

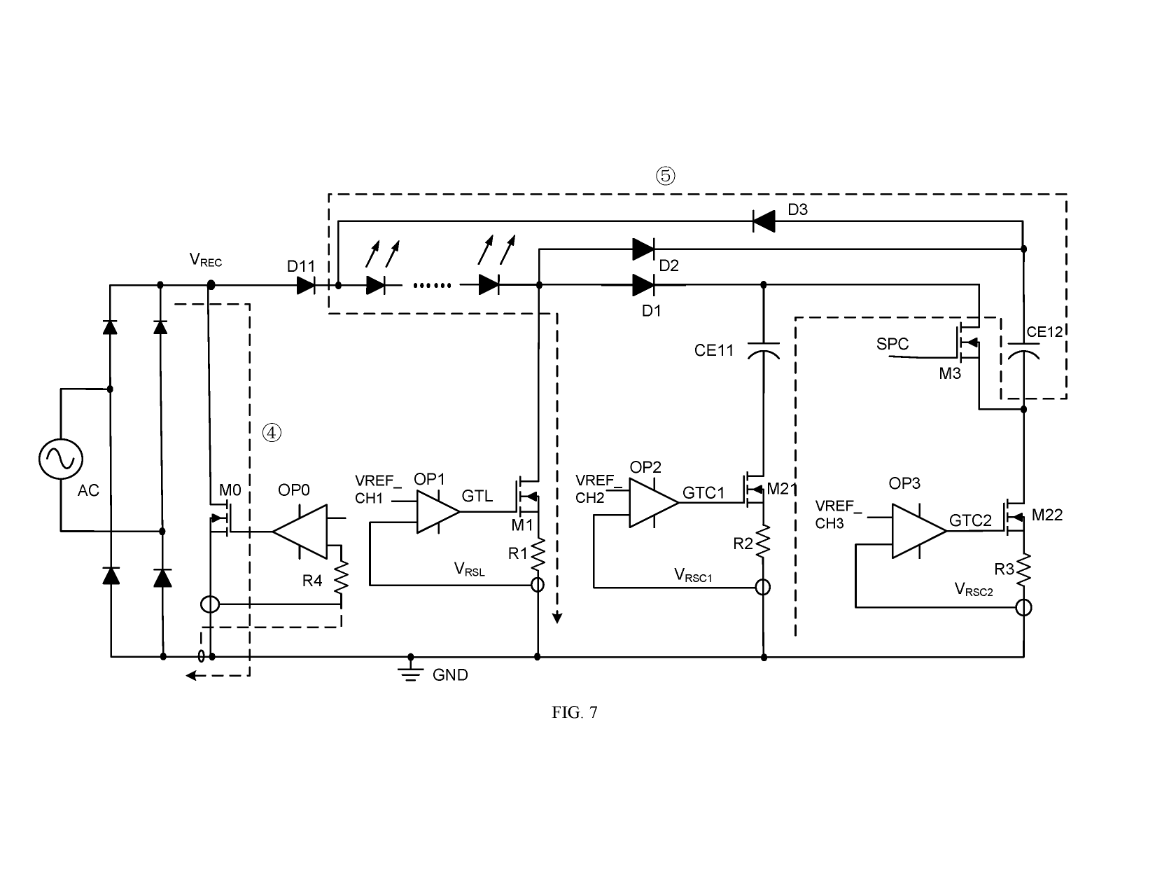

The LED lighting control system described in FIG. 1 to FIG. 4 may be referred to as a first LED lighting control system. FIG. 6A is a circuit diagram of a second LED lighting control system according to embodiments of the present disclosure, where some current loops of the second LED lighting control system are shown. FIG. 6B is a signal control circuit of a constant current control circuit, where the constant current control circuit is applicable to the first LED lighting control system and the second lighting control system. FIG. 7 shows other current loops of the second LED lighting control system according to embodiments of the present disclosure. The second LED lighting control system includes a rectifier circuit and multiple LED current paths. The anode of the LED load is connected to the output terminal of the rectifier circuit to receive the half-wave power frequency input voltage V_{REC}. The multiple LED current paths are connected between the cathode of the LED load and ground. The multiple LED current paths include a first switching current path, and at least two parallel capacitor current paths. For example, a capacitor current path includes a first unidirectional conducting element (such as diode D1 or D2), a first electrolytic capacitor CE11 or CE12, and a second switch M21 or M22. The first unidirectional conducting element is connected to the cathode of the LED load. A first switching current path includes a first switch M1.

As shown in FIG. 6A, FIG. 6B and FIG. 7, the constant current control circuit includes a signal control circuit and multiple operational amplifiers. The signal control circuit is configured to receive feedback current sampling information from multiple current paths, and amplify errors with a reference value to generate multiple reference signals. The constant current control circuit performs amplification of errors between the feedback current sampling information from multiple current paths and the multiple reference signals, and controls the operating current of a corresponding current path based on the corresponding error amplification result, thereby realizing constant current control of the LED load. For example, based on the feedback current sampling information of the first switching current path and a reference signal, an error amplification result is obtained to control the operating current of the first switching current path. This embodiment also includes a second unidirectional conducting element D3, which includes a diode D3. The second unidirectional conducting element is connected between the second terminal of the electrolytic capacitor CE12 and the anode of the LED load.

In some embodiments, referring to FIG. 6A, the first switching current path includes a first switch M1, and at least two parallel capacitor current paths including a first capacitor current path and a second capacitor current path. The first capacitor current path and the second capacitor current path respectively include second switches M21 and M22. The multiple reference signals include the first reference signal VREF_CH1, the second reference signal VREF_CH2, and the third reference signal VREF_CH3. The constant current control circuit is configured to amplify the error between the feedback current sampling information V_{RSL} of the first switching current path and the first reference signal VREF_CH1, and control the operating state of the first switch M1 based on the error amplification result to control the current of that path.

The constant current control circuit also performs error amplification on the feedback current sampling information V_{RSC1} and V_{RSC2} of the two capacitor current paths with a second reference signal VREF_CH2 and a third reference signal VREF_CH3 respectively, and controls the operating states of the second switches M21 and M22 based on the error amplification results to control the currents of the corresponding paths. For example, the constant current control circuit may control to turn on or off the second switches M21 and M22 to cause the corresponding paths to have current or have no current to flow through, and may control the conduction levels of the second switches M21 and M22 in order to control the current magnitudes.

The constant current control circuit may further include three operational amplifiers. A first operational amplifier (OP1) receives the feedback current sampling information V_{RSL} from the first switching current path and the first reference signal VREF_CH1, and outputs, at the output terminal of OP1, an error amplification result to the control terminal of the first switch M1. The second and third operational amplifiers (OP2 and OP3) respectively receive the feedback current sampling information V_{RSC1} and V_{RSC2} from the two capacitor current paths, and the second reference signal VREF_CH2 and the third reference signal VREF_CH3, and respectively transmit the corresponding error amplification results to the control terminals of the second switches M21 and M22.

As shown in FIG. 6A and FIG. 7, the LED lighting control system further includes a third switch M3. The third switch M3 is connected between the two parallel capacitor current paths. When the third switch M3 is turned on, the electrolytic capacitors in the two parallel capacitor current paths supply power to the LED load in series, as shown in current loop ⑤ in FIG. 7. Specifically, in current loop ⑤ of FIG. 7, the current flows sequentially through the electrolytic capacitor CE11, the third switch M3, the electrolytic capacitor CE12, the diode D3, the LED load, the first switch M1 and ground, thereby forming a current loop.

As shown in FIG. 6B, the signal control circuit of this embodiment includes a voltage compare circuit. The voltage compare circuit is configured to receive the input voltage V_{REC} and a first threshold voltage V_{F}. When the input voltage V_{REC} is less than the first threshold voltage V_{F}, the voltage comparison circuit outputs a comparison signal (SPC) to control the third switch M3 to turn on. The first threshold voltage V_{F} is less than or equal to a load operating voltage. This embodiment uses "equal to" as an example, but the first threshold being less than the load operating voltage also satisfies the implementation scheme of the present disclosure. Specifically, in this embodiment, the third switch M3 is connected between the electrolytic capacitors CE11 and CE12 in the two parallel capacitor current paths. When the third switch is turned on, the two electrolytic capacitors CE11 and CE12 form a series path. When the input voltage is less than the first threshold voltage, the first switch M1 is also turned on. The two electrolytic capacitors CE11 and CE12 form a discharge circuit through the third switch M3 and the first switch M1 to supply power to the LED load, as shown in current loop ⑤ in FIG. 7.

The signal control circuit may be configured to obtain the first feedback current sampling information V_{RSL} by sampling the current of the first switching current path through a first sampling resistor R1_{.} The constant current control circuit obtains the second feedback current sampling information V_{RSC1} and the third feedback current sampling information V_{RSC2} by sampling the current information of the two parallel capacitor current paths through a second sampling resistor R2 and a third sampling resistor R3. The first sampling resistor R1 is connected in series at a certain position in the first switching current path, e.g., between a switch and the ground or between a switch and the cathode of the LED load. The second and third sampling resistors R1 and R2 are respectively connected in series at certain positions in the two parallel capacitor current paths, e.g., between a switch and the ground, between an electrolytic capacitor and a switch, or between an electrolytic capacitor and the cathode of the LED load. FIG. 6A and FIG. 7 show an example where the sampling resistors are each connected between a switch and the ground.

In one example, the first sampling resistor R1, the second sampling resistor R2, and the third sampling resistor R3 have the same resistance value, and the first reference signal VREF_CH1, the second reference signal VREF_CH2, and the third reference signal VREF_CH3 have different values, e.g., VREF_CH1 = 2 * VREF_CH2 = 2 * VREF_CH3, where the second and third reference signals have the same value. In another example, the first sampling resistor R1, the second sampling resistor R2, and the third sampling resistor R3 have different resistance values, e.g., R1 = 0.5R2 = 0.5R3, and the first reference signal VREF_CH1, the second reference signal VREF_CH2 and the third reference signal VREF_CH3 have the same value, where the second and third sampling resistors have the same resistance value. Both combinations (i.e., these two examples above) allow for sampling the current information of the present load from the first capacitor current path and the second capacitor current path even after the first switching current path is turned off , thus achieving closed-loop control of the output current. The first capacitor current path and the second capacitor current path may have the same circuit structure and the same device parameters. Therefore, by designing the reference signals or the resistance values, accurate sampling and feedback of the load current can be achieved, thereby controlling the LED load to operate at a constant current.

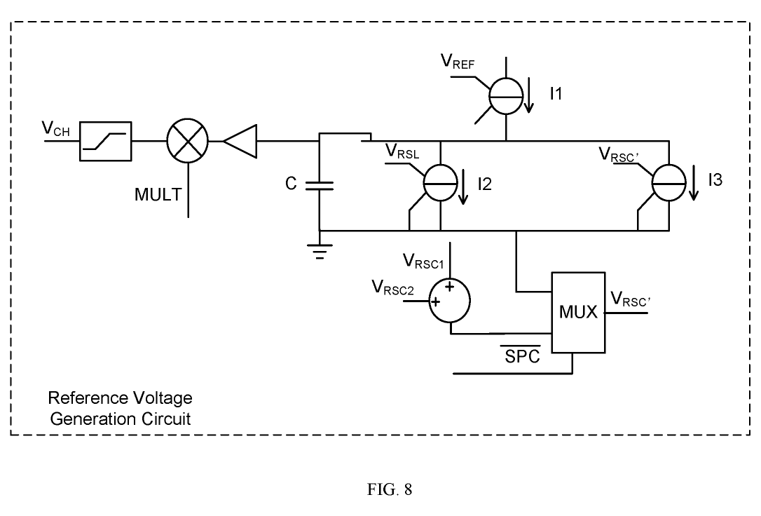

Referring to FIG. 6B, FIG. 7 and FIG. 8, the signal control circuit of the embodiments of the present disclosure may further include a reference voltage generation circuit. FIG. 8 shows an example implementation of the reference voltage generation circuit. The reference voltage generation circuit is configured to receive feedback current sampling information (V_{RS}) from multiple current paths and a reference value VREF. The reference voltage generation circuit obtains a first current I1 (as a charging current) based on the reference value VREF, and a second current (as a discharging current) based on the feedback current sampling information from the multiple current paths. The first current I1 and the second current charge and discharge a first capacitor C to obtain a capacitor voltage V_{CH}.The capacitor voltage V_{CH} is multiplied by different coefficients to obtain the multiple reference signals. The second current is the superposition of currents I2 and I3. The feedback current sampling information V_{RSC1} and V_{RSC2} of the multi-path current path are fed back together, and only the positive current part of V_{RSC1} and V_{RSC2} is fed back. Therefore, the second current is the sum of V_{RSL} and V_{RSC'} (when V_{RSC1} + V_{RSC2} > 0), as shown in FIG. 8. The reference voltage generation circuit includes multiple voltage-controlled current sources to generate the first current I1 and the second current according to the reference value VREF and the feedback current sampling information. V_{RSC1} + V_{RSC2}is obtained first by superposition using an adder, and then the positive current is selected by a multiplexer MUX to obtain the voltage V_{RSC'}.

Referring back to FIG. 7, the constant current control circuit of embodiments of the present disclosure may also include a zeroth (0^{th}) switching current path, which is connected between the output terminal and the ground terminal of the rectifier circuit. The zeroth switching current path includes a zeroth switch M0. When the input voltage is less than a first threshold voltage, the zeroth switch M0 is turned on, and the zeroth switching current path forms a conduction loop with the rectifier circuit. The first threshold voltage is less than or equal to the load operating voltage. The constant current control circuit also includes a zeroth operational amplifier, which detects the current information of the zeroth switching current path and compares it with a reference signal to control the operating state of the zeroth switch M0, thereby controlling the operating current of that path. The reference signal may be selected based on the magnitude of the input voltage, which allows to control the input current to be a sinusoidal or quasi-sinusoidal envelope, achieving power factor correction. The zeroth (0^{th}) switching current path ensures that current may still be drawn from the grid when the input voltage is relatively low, improving the power factor and reducing harmonic distortion.

Referring again to FIG. 7, a first diode D11 may also be included between the output terminal of the rectifier circuit and the anode of the LED load. The anode of the first diode D11 is connected to the output terminal of the rectified current, and the cathode of the first diode D11 is connected to the anode of the LED load. A connection node of the zeroth switching current path is connected between the output terminal of the rectifier circuit and the anode of the first diode D11. The diode D11 is arranged here to prevent the current from the electrolytic capacitors from flowing back to the input terminal.

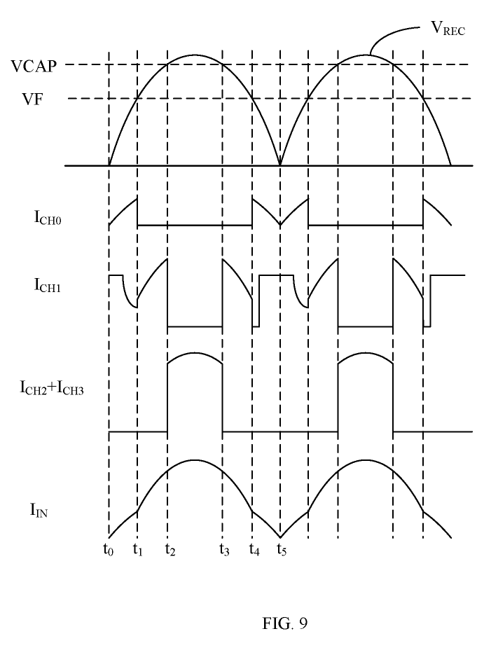

Based on the circuit architecture of embodiments of the present disclosure and in conjunction with waveform diagram of FIG. 9, the working principle of constant current control of the present disclosure is described as follows. Within the period of the half-wave power frequency input voltage, when the input voltage V_{REC} is lower than the first threshold voltage V_{F}, e.g., in the time interval t0-t1, the third switch M3 is turned on, the parallel electrolytic capacitors supply power to the LED load together, and the circuit branch where the first switch M1 is located has current I_{CH1} flowingthrough, as shown in current loop ⑤ in FIG. 7. No current flows through the parallel capacitor current paths, I_{CH2} and I_{CH3}are zero, and the zeroth switch M0 is turned on, with current I_{CH0} flowingthrough the branch where the zeroth switch M0 is located, as shown in current loop ④ in FIG. 4. Specifically, in current loop ④ of FIG. 7, the current flows sequentially from the output terminal of the rectifier circuit to the zeroth switch M0 and ground, thereby forming a current loop.

When the input voltage V_{REC} is higher than the first threshold voltage V_{F} but lower than the second threshold voltage V_{CAP}, e.g., in the time interval t1-t2, the first switch M1 is turned on, the parallel capacitor current paths are disconnected, the input voltage V_{REC} supplies power to the LED load, and the circuit branch where the first switch M1 is located has current I_{CH}₁ flowing through it, as shown in current loop ① in FIG. 6A. Specifically, in current loop ① of FIG. 6A, current flows sequentially from the output terminal of the rectifier circuit to the LED load, the first switch M1 and ground, thereby forming a current loop.

When the input voltage V_{REC} is higher than the second threshold voltage V_{CAP}, e.g., in the time interval t2-t3, the first switch M1 is turned off, the second switches M21 and M22 are turned on, the parallel capacitor current paths conduct, the input voltage V_{REC} supplies power to the LED load and charges the electrolytic capacitors in the parallel capacitor current paths, as shown in current loop ② and current loop ③ in FIG. 6A.Specifically, in current loop ② of FIG. 6A, current flows sequentially from the output terminal of the rectifier circuit to the LED load, the diode D1, the electrolytic capacitor CE11, the second switch M21 and ground, thereby forming a current loop. In current loop ③ of FIG. 6A, current flows sequentially from the output terminal of the rectifier circuit to the LED load, the diode D2, the electrolytic capacitor CE12, the second switch M22 and ground, thereby forming a current loop.

Thereafter, when the input voltage V_{REC} decreases to be below the second threshold voltage V_{CAP} but above the first threshold voltage V_{F}, e.g., in the time interval t3-t4, similar to the situation during the time interval t1-t2, the first switch is turned on, the third switch is turned off, the circuit branch where the first switch M1 is located has current I_{CH1} flowing through_{,} the parallel capacitor current paths have no current flowing through, and I_{CH2} and I_{CH3} are zero. Then, in the time interval t4-t5, the input voltage V_{REC} decreasesto the first threshold voltage V_{F},similar to the situation during the time interval t0-t1, the first switch is turned on, and the circuit branch where the first switch is located has current I_{CH1} flowingthrough, the zeroth switch is turned on and the circuit branch where the zeroth switch is located has current I_{CH0} flowingthrough.

Based on the above process, the system's input current waveform is shown by I_{IN}, which is close to the input voltage waveform, resulting in a better power factor and low harmonics. Furthermore, during the conduction of each path, the operating current is controlled in a closed loop based on the feedback current signal and the reference signal, enabling to control the LED's operating current to be a constant current.

Embodiments of the present disclosure provide a constant current control scheme for LED lighting control systems. By sampling feedback current information from multiple current paths and amplifying errors with respect to reference values, multiple reference voltage signals are generated for use by the multiple current paths. An operational amplifier is configured to amplify an error between a reference voltage signal and a feedback current signal of each path, thereby achieving closed-loop control of the LED load current. The constant current control circuit for LED lighting control systems in embodiments of the present disclosure achieves low-harmonicity, and high-efficiency linear LED driver constant current control for single-range LED loads, with good constant current control accuracy.

It should be noted that the specific implementations and corresponding illustrations provided are merely one way of describing the implementation methods of the present disclosure, and are not intended to limit the specific structures of the implementation schemes of the present disclosure. Various changes or modifications can be made to these implementation schemes without departing from the principles and essence of the present disclosure, but all such changes and modifications fall within the protection scope of the present disclosure.

Although the embodiments are described and illustrated separately above, those ordinarily skilled in the art would recognize that, certain involved common technologies may be replaced or integrated between the embodiments, and for content not explicitly described in one embodiment, reference may be made to another embodiment that has the content described.

The embodiments described above do not constitute a limitation on the scope of protection of the technical solution. Any modifications, equivalent substitutions, and improvements made and so on within the spirit and principle of the above embodiments should be included within the protection scope of the technical solution.

Although the description has been described in detail, it should be understood that various changes, substitutions and alterations can be made without departing from the spirit and scope of this disclosure as defined by the appended claims. Moreover, the scope of the disclosure is not intended to be limited to the particular embodiments described herein, as one of ordinary skill in the art will readily appreciate from this disclosure that processes, machines, manufacture, compositions of matter, means, methods, or steps, presently existing or later to be developed, which may perform substantially the same function or achieve substantially the same result as the corresponding embodiments described herein, may be utilized according to embodiments of the present disclosure. Accordingly, the appended claims are intended to include within their scope such processes, machines, manufacture, compositions of matter, means, methods, or steps.

What is claimed:

1. An LED lighting control system for controlling an LED load, comprising:
a rectifier circuit, configured to rectify an alternating current to obtain an input voltage, the input voltage being a half-wave voltage at a power frequency, and an anode of the LED load being connected to an output terminal of the rectifier circuit;
a first switch, connected between a cathode of the LED load and ground;
two parallel capacitor paths, connected between the cathode of the LED load and the ground, each capacitor path of the two parallel capacitor paths including a first unidirectional conducting element, a first electrolytic capacitor, and a second switch, and the first unidirectional conducting element being connected to the cathode of the LED load; and
a third switch, connecting the two parallel capacitor paths such that when the third switch is turned on, two first electrolytic capacitors in the two parallel capacitor paths form a series discharge path.

2. The LED lighting control system of claim 1, wherein,
when the input voltage is lower than a first threshold voltage, the first switch is turned on, the third switch is turned on, and the two first electrolytic capacitors in the parallel capacitor paths supply power to the LED load;
when the input voltage is higher than the first threshold voltage and lower than a second threshold voltage, the first switch is turned on, the two parallel capacitor paths are disconnected, and the input voltage supplies power to the LED load;
when the input voltage is higher than the second threshold voltage, the first switch is turned off, the two parallel capacitor paths conduct, and the input voltage supplies power to the LED load and charges the two first electrolytic capacitors in the two parallel capacitor paths; and
the first threshold voltage is a load operating voltage, and the second threshold voltage is a sum of the load operating voltage and a voltage of the first electrolytic capacitor.

3. The LED lighting control system of claim 2, further comprising a second unidirectional conduction element,
wherein the two parallel capacitor paths include a first capacitor path and a second capacitor path,
a first terminal of the first electrolytic capacitor in the first capacitor path is connected to the second switch in the first capacitor path, and a second terminal of the first electrolytic capacitor in the first capacitor path is connected to a first power terminal of the third switch,
a first terminal of the first electrolytic capacitor in the second capacitor path is connected to a second power terminal of the third switch, and to the second switch in the second capacitor path, and
the second unidirectional conducting element is connected between the second terminal of the first electrolytic capacitor in the second capacitor path and the anode of the LED load.

4. The LED lighting control system of claim 2, wherein,
when the input voltage is lower than the first threshold voltage, the first switch is turned on, and the third switch is turned on,
a current flows sequentially from the first electrolytic capacitor in the first capacitor path, through the third switch, the first electrolytic capacitor in the second capacitor path to the LED load, forming a power circuit through the first switch.

5. The LED lighting control system of claim 1, wherein the first unidirectional conducting element includes a diode, which has an anode connected to the LED load and a cathode connected to the first electrolytic capacitor or the second switch.

6. The LED lighting control system of claim 1, further comprising:
a first switch control circuit for controlling the first switch, wherein he first switch control circuit is configured to:
receive a first reference voltage and a first current feedback signal, and
amplify an error between the first reference voltage and the first current feedback signal to obtain a first error output signal to control conduction state of the first switch.

7. The LED lighting control system of claim 1, further comprising two second switch control circuits, configured to control respectively second switches in the two parallel capacitor paths,
wherein each of the two second switch control circuits is configured to receive a reference voltage and a current feedback signal, and obtain an error output signal by amplifying an error between the reference voltage and the current feedback signal, to control a conduction state of the second switch.

8. The LED lighting control system of claim 1, further comprising a third capacitor path connected between the cathode of the LED load and the ground, the third capacitor path including a third electrolytic capacitor connected to the two parallel capacitor paths through a fourth switch;
wherein when the input voltage is lower than the first threshold voltage, the third switch and the fourth switch are turned on, and the two first electrolytic capacitors in the two parallel capacitor paths and the third electrolytic capacitor in the third capacitor path discharge in series to supply power to the LED load.

9. A constant current control circuit for an LED lighting control system, the LED lighting control system comprising a rectifier circuit and a plurality of LED current paths, wherein an anode of an LED load is configured to receive an input voltage of a half-wave at a power frequency that is output from the rectifier circuit, and the plurality of LED current paths are connected between a cathode of the LED load and ground;
wherein the plurality of LED current paths include a first switching current path and at least two parallel capacitor current paths; and
wherein the constant current control circuit is connected to a current sampling terminal of the plurality of LED current paths and a current control terminal of the plurality of LED current paths; and
the constant current control circuit comprises:
a signal control circuit, configured to receive feedback current sampling information from the plurality of LED current paths, and amplify an error between the feedback current sampling information and a reference value to generate a plurality of reference signals; and
a plurality of operational amplifiers, configured to amplify errors between the feedback current sampling information of the plurality of LED current paths and the plurality reference signals, to control one or more operating currents of the plurality of LED current paths based on error amplification results, thereby realizing constant current control of the LED load.

10. The constant current control circuit of claim 9, wherein the first switching current path includes a first switch;
the at least two parallel capacitor current paths include a first capacitor current path and a second capacitor current path, and each of the first capacitor current path and the second capacitor current path includes a second switch;
the plurality of reference signals include a first reference signal, a second reference signal, and a third reference signal; and
the constant current control circuit is configured to:
amplify an error between the feedback current sampling information of the first switching current path and the first reference signal, and control an operating state of the first switch according to an error amplification result to control a current of the first switching current path; and
amplify errors between the feedback current sampling information of the first capacitor current path and the second capacitor current path and the second reference signal and the third reference signal respectively, and control an operating state of the second switch of a corresponding capacitor current path according to a corresponding error amplification result to control a current of the corresponding capacitor current path.

11. The constant current control circuit of claim 10, wherein the LED lighting control system further includes a third switch connected between two parallel capacitor current paths of the at least two parallel capacitor current paths; and
when the third switch is turned on, electrolytic capacitors in the two parallel capacitor current paths supply power to the LED load.

12. The constant current control circuit of claim 11, further comprising a voltage comparison circuit configured to:
receive the input voltage and a first threshold voltage; and
when the input voltage is less than the first threshold voltage, output a comparison signal to control to turn on the third switch;
wherein the first threshold voltage is less than or equal to a load operating voltage.

13. The constant current control circuit of claim 12, wherein,
when the input voltage is higher than the first threshold voltage and lower than a second threshold voltage, the first switch is turned on, the at least two parallel capacitor current paths are disconnected, and the input voltage supplies power to the LED load; and
when the input voltage is higher than the second threshold voltage, the first switch is turned off, the at least two parallel capacitor current paths conduct, and the input voltage supplies power to the LED load and charges electrolytic capacitors in the at least two parallel capacitor current paths;
the second threshold voltage is a sum of the load operating voltage and an electrolytic capacitor voltage.

14. The constant current control circuit of claim 10, wherein the constant current control circuit is further configured to:
obtain first feedback current sampling information by sampling a current of the first switching current path through a first sampling resistor; and
obtain second feedback current sampling information and third feedback current sampling information by sampling current information of the two parallel capacitor current paths through a second sampling resistor and a third sampling resistor, respectively.

15. The constant current control circuit of claim 14, wherein resistance values of the first sampling resistor, the second sampling resistor, and the third sampling resistor are same, and a value of the first reference signal is different from a value of the second reference signal, and the values of the second reference signal and the third reference signal are same.

16. The constant current control circuit of claim 14, wherein resistance values of the first sampling resistor and the second sampling resistor are different, the second sampling resistor and the third sampling resistor have a same resistance value, and values of the first reference signal, the second reference signal, and the third reference signal are same.

17. The constant current control circuit of claim 10, further comprising:
a first operational amplifier, configured to receive the feedback current sampling information from the first switching current path and the first reference signal, and output the error amplification result to a control terminal of the first switch;
a second operational amplifier and a third operational amplifier, configured to receive respectively the feedback current sampling information from the first capacitor current path and the second capacitor current path, the second reference signal and the third reference signal, and respectively transmit error amplification results to control terminals of the second switches of first capacitor current path and the second capacitor current path.

18. The constant current control circuit of claim 10, further comprising a reference voltage generation circuit configured to:
receive feedback current sampling information from the plurality of LED current paths and a reference value;
obtain a first current based on the reference value, and obtain a second current based on the feedback current sampling information of the plurality of LED current paths;
wherein a capacitor voltage is obtained by using the first current and the second current charging and discharging an electrolytic capacitor, and the plurality of reference signals are obtained by multiplying the capacitor voltage by different coefficients.

19. The constant current control circuit of claim 9, further comprising a zeroth switching current path connected between an output terminal of the rectifier circuit and the ground, the zeroth switching current path includes a zeroth switch;
wherein when the input voltage is less than a first threshold voltage, the zeroth switch is turned on, and the zeroth switch current path forms a conduction loop with the rectifier circuit, the first threshold voltage being less than or equal to a load operating voltage.

20. The constant current control circuit of claim 19, further comprising a first diode, wherein an anode of the first diode is connected to an output terminal of the rectified current, and a cathode of the first diode is connected to the anode of the LED load; and
a connection node of the zeroth switching current path is connected between the output terminal of the rectifier circuit and the anode of the first diode.
